(19) United States
(12) Patent Application Publication
(10) Pub. No.: US 2007/0157788 A1
(43) Pub. Date: Jul. 12, 2007

(54) Twelve piece soundboard for stringed musical instruments

(76) Inventor: Robert A. Meilleur, North Bay (CA)

Correspondence Address: ROBERT A. MEILLEUR, 208 KING ST. W., NORTH BAY, ON, P1B5Z8, CA

(21) Appl. No.: 11/327,001

(22) Filed: Jan. 6, 2006

(51) Int. Cl. G10D 3/00

(52) U.S. Cl. 84/291

(57) ABSTRACT

Soundboards of stringed musical instruments, such as guitars, are usually made of 2 pieces of matched wood and are usually braces in an X configuration. This author uses 12 triangular pieces, shaped like wedges, each cut to 30 degrees. The apex or point of each piece terminates under the bridge. The bases or wide parts are shaped, terminated and attached to the sides or rims of the instrument. Each piece or wedge is braced along each joint on the underside of the soundboard. each brace terminates under the bridge and resembles the spokes of a wheel. A plate, the same size and shape as the bridge is attached to the braces directly under the bridge. The bridge is attached to the top directly over the plate and where all the top's pieces join together. The bridge pin holes are configured as to not go through the braces.

I, Robert A. Meilleur, have invented a new type of soundboard for stringed musical instruments such as guitars. It consists of 12 wedge shaped pieces as set forth in the following specification:

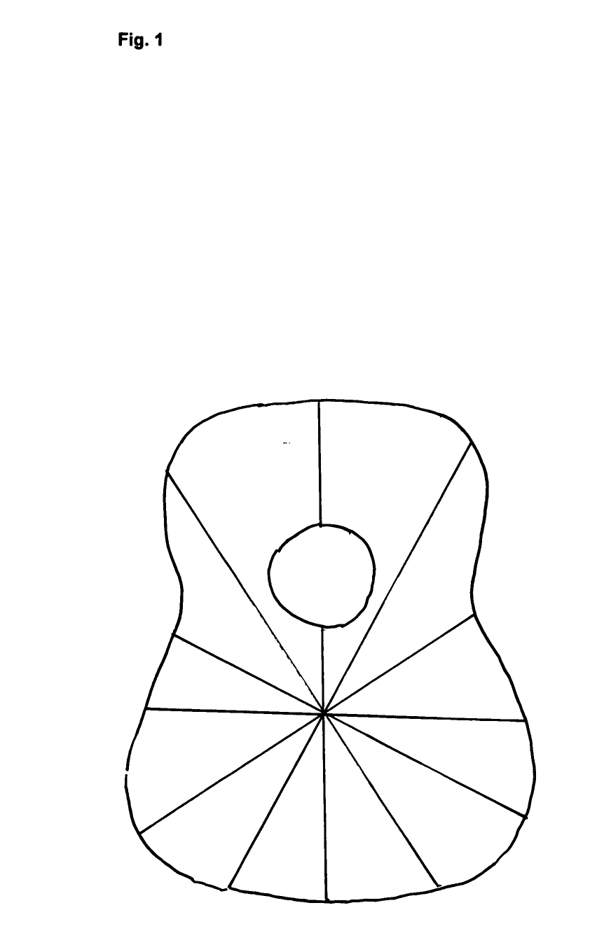

FIG. 1 is a frontal view of the soundboard

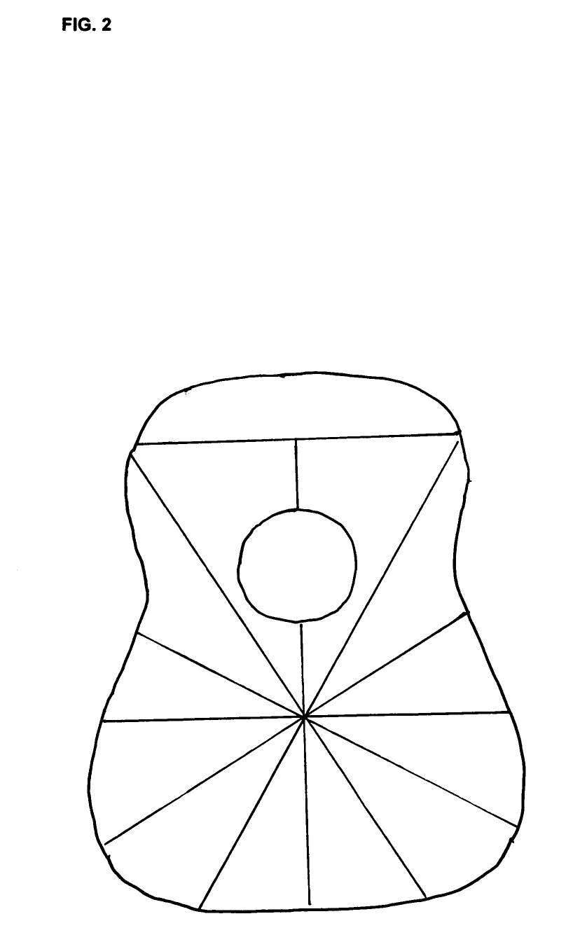

FIG. 2 is a view of the internal bracing

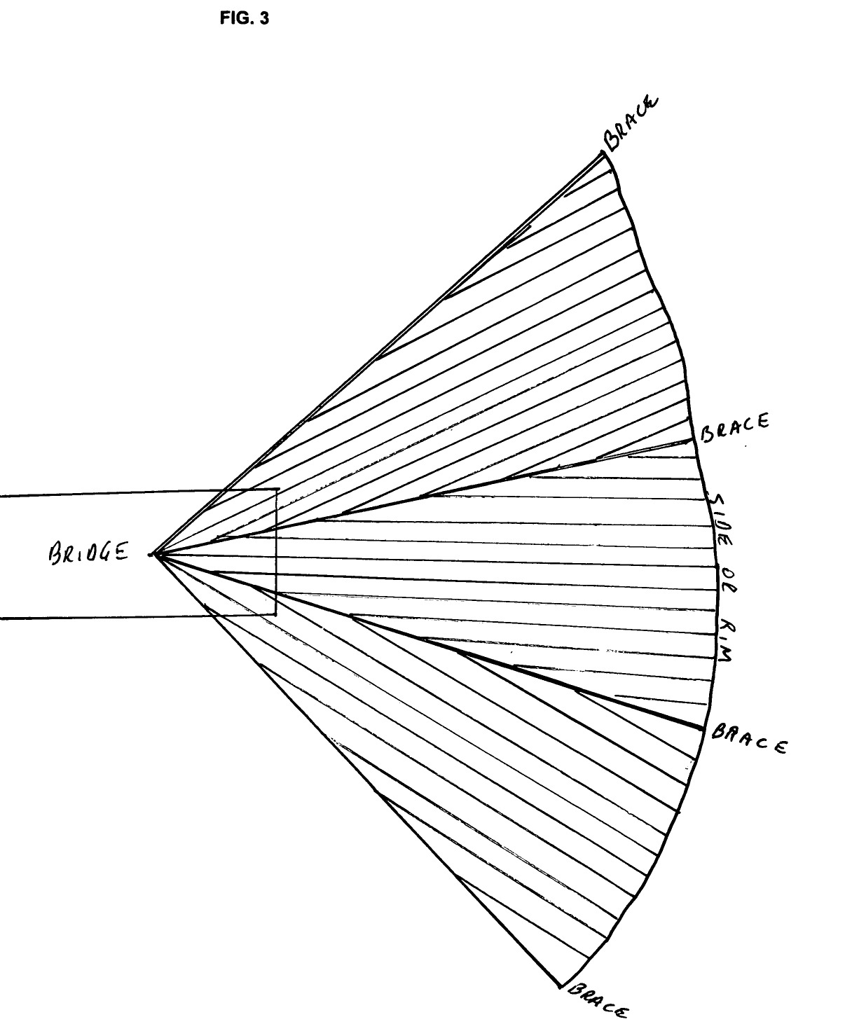

FIG. 3 is a view of 3 of the 12 typical pieces.

1. Since the musical properties and conductivity of wood is 16 times better WITH the grain than AGAINST the grain, it makes good sense to avoid, eliminate or reduce CROSS bracing in soundboards of musical instruments. This makes for a better, smoother uninterrupted transition of sound.

2. The resulting configuration is more aesthetically pleasing.

3. Since the instrument is made of 6″ wood, as opposed to the more expensive 8″ wood, monetary savings are realized.

4-11. (canceled)
